(19) United States
(12) Patent Application Publication
(10) Pub. No.: US 2021/0312281 A1
(43) Pub. Date: Oct. 7, 2021

(54) APPARATUS FOR INSTRUCTION GENERATION FOR ARTIFICIAL INTELLIGENCE PROCESSOR AND OPTIMIZATION METHOD THEREOF

(71) Applicant: Electronics and Telecommunications Research Institute, Daejeon (KR)

(72) Inventor: Hyun Mi KIM, Daejeon (KR)

(73) Assignee: ELECTRONICS AND TELECOMMUNICATIONS RESEARCH INSTITUTE, Daejeon (KR)

(21) Appl. No.: 17/217,777

(22) Filed: Mar. 30, 2021

(30) Foreign Application Priority Data
Apr. 2, 2020 (KR) 10-2020-0040549

(51) Int. Cl. G06N 3/08; G06N 3/04

(52) U.S. Cl. CPC G06N 3/08; G06N 3/04

(57) ABSTRACT

An apparatus for automatically generating instructions for an artificial intelligence processor and a method for optimizing the same are provided. The method includes: obtaining a combination of conditions for actions performed by the artificial intelligence processor in consideration of optimization condition information for the actions based on model optimization information that optimizes a neural network model to which the artificial intelligence processor is applied and configuration information of the artificial intelligence processor; generating hardware modeling based on the combination of conditions and predicting a performance value through the hardware modeling; and determining an optimal combination of conditions by comparing the predicted performance value and a preset optimal performance value.

### CROSS-REFERENCE TO RELATED APPLICATION

This application claims priority to and the benefit of Korean Patent Application No. 10-2020-0040549 filed in the Korean Intellectual Property Office on Apr. 2, 2020, the entire contents of which are incorporated herein by reference.

### BACKGROUND OF THE DISCLOSURE

### (a) Field of the Disclosure

The present disclosure relates to an apparatus for automatically generating instructions for an artificial intelligence processor and a method for optimizing the same.

### (b) Description of the Related Art

With the advancement in the field of artificial intelligence, the need for an artificial intelligence processor with a dedicated acceleration function emerges. In general, an artificial intelligence processor consists of an external memory for storing input/output data and weight data, a calculator for accelerating vector or matrix calculations that occupy most operations of deep learning algorithms, and an internal memory for quickly suppling data to the calculator and storing the output data.

The AI-only processor configured in this way defines and uses dedicated instructions to be programmable in order to respond to various neural network models. Although the artificial intelligence processor accelerates the neural network with a specific function different from the general purpose processor, it must be programmable and better performance than the existing general processor or graphics processor is required, in order to cope with various and rapidly changing neural network algorithms.

In addition, a compiler, a system that automatically generates instructions for operating an artificial intelligence processor with the required functions and performance with the highest performance according to various neural network models, is essential. However, the existing compilers are focused on optimizing the central processing unit (CPU) and graphics processing unit (GPU) hardware for processing deep learning algorithms, so a dedicated compiler for an artificial intelligence processor is required. In particular, for the automatic code generator of the existing deep learning system, the focus is on the automatic code generation apparatus without presenting a specific performance optimization function, or it deals with optimization for other hardware such as CPU code or image processing hardware platform, thereby it is difficult to use.

The above information disclosed in this Background section is only for enhancement of understanding of the background of the disclosure, and therefore it may contain information that does not form the prior art that is already known in this country to a person of ordinary skill in the art.

### SUMMARY OF THE DISCLOSURE

The present disclosure has been made in an effort to provide is to provide an apparatus for automatically generating instructions and an optimization method therefor so that an artificial intelligence dedicated processor (or a deep learning accelerator of a neural network) can process various neural network models with the most optimal performance.

According to an embodiment of the present disclosure, a method of optimizing an artificial intelligence processor is provided. The method includes: obtaining a combination of conditions for actions performed by the artificial intelligence processor in consideration of optimization condition information for the actions based on model optimization information that optimizes a neural network model to which the artificial intelligence processor is applied and configuration information of the artificial intelligence processor; generating hardware modeling based on the combination of conditions and predicting a performance value through the hardware modeling; and determining an optimal combination of conditions by comparing the predicted performance value and a preset optimal performance value.

In an implementation, the determining of an optimal condition combination may include updating the optimal performance value to a smaller value as a result of comparing the predicted performance value with the preset optimal performance value.

In an implementation, the predicting of a performance value and the updating may be repeatedly performed for a combination of conditions that can be combined to perform the actions. In this case, the determining of an optimal condition combination may include determining an optimal combination of conditions when the predicting of a performance value and the updating are performed for all conditions included in the condition combination. In an implementation, the optimization condition information may include an allocation ratio of input data, weight data, and output data to the internal memory of the artificial intelligence processor, tiling information for dividing the entire data, data division information, whether or not to reuse data between adjacent layers of a neural network, whether or not to apply a double buffering technique to enable parallel operation in consideration of dependency between the actions for each action operation, and scheduling of actions.

In an implementation, the actions may include a first action of loading input data from an external memory of the artificial intelligence processor to an internal memory, a second action of loading weight data from the external memory, a third action of the artificial intelligence processor performing an operation, and a fourth action of storing result data of the operation to the external memory.

In an implementation, the obtaining of a combination of conditions may include obtaining a first condition combination, based on the allocation ratio, the whether or not to apply a double buffering technique, and the scheduling of actions, by combining a double buffering condition, and a condition for simultaneous access to the internal memory for input data and output data for the third action, and whether the total weights is allocated, wherein the first condition combination corresponds to scheduling-related search spaces.

In an implementation, the first condition combination may include a scheduling related search space according to a weight priority mode and a scheduling related search space according to an input data priority mode. In an implementation, the obtaining of a combination of conditions may include: obtaining a second condition combination by combining the tiling information with the first condition combination; obtaining a third condition combination by combining the data division information with the second condition combination; and obtaining a fourth condition combination by recombining a scheduling condition based on whether or not to reuse data in the third condition combination.

In an implementation, the predicting of a performance value may include generating hardware modeling based on the fourth condition combination and predicting a performance value through the hardware modeling.

In an implementation, the predicting of a performance value may predict the performance value for each action performed by the artificial intelligence processor through the hardware modeling. In this case, after the predicting of a performance value, the method may further include assigning a weight to the predicted performance value for each action, and correcting the weight assigned for each action according to a ratio of an actual performance value obtained by a test for each action and the predicted performance value for each action.

In an implementation, the artificial intelligence processor may be an accelerator of a systolic array structure.

According to another embodiment of the present disclosure, an apparatus of generating an instruction for an action of an artificial intelligence processor is provided. The apparatus includes: an interface device; and a processor connected to the interface device and configured to obtain optimal combination of conditions for actions performed by the artificial intelligence processor based on model optimization information that optimizes a neural network model to which the artificial intelligence processor is applied and configuration information of the artificial intelligence processor and generate an instruction according to the optimal condition combination, wherein the processor may be configured to perform the following operations: obtaining a combination of conditions for actions performed by the artificial intelligence processor in consideration of optimization condition information for the actions; generating hardware modeling based on the combination of conditions and predicting a performance value through the hardware modeling; and determining an optimal combination of conditions by comparing the predicted performance value and a preset optimal performance value.

In an implementation, the processor may be configured to update the optimal performance value to a smaller value as a result of comparing the predicted performance value with the preset optimal performance value, and the predicting of a performance value and the updating may be repeatedly performed for a combination of conditions that can be combined to perform the actions.

In an implementation, the processor may be configured to determine an optimal combination of conditions when the predicting of a performance value and the updating are performed for all conditions included in the condition combination and generate an instruction according to the optimal condition combination.

In an implementation, the optimization condition information may include an allocation ratio of input data, weight data, and output data to the internal memory of the artificial intelligence processor, tiling information for dividing the entire data, data division information, whether or not to reuse data between adjacent layers of a neural network, whether or not to apply a double buffering technique to enable parallel operation in consideration of dependency between the actions for each action operation, and scheduling of actions.

In an implementation, the actions performed by the artificial intelligence processor may include a first action of loading input data from an external memory of the artificial intelligence processor to an internal memory, a second action of loading weight data from the external memory, a third action of the artificial intelligence processor performing an operation, and a fourth action of storing result data of the operation to the external memory.

In an implementation, when performing the obtaining of a combination of conditions, the processor may be configured to perform the following operation: obtaining a first condition combination, based on the allocation ratio, whether or not to apply a double buffering technique, and scheduling of actions, by combining a double buffering condition, a condition for simultaneous access to the internal memory for input data and output data for the third action, and whether the total weights are allocated, wherein the first condition combination corresponds to scheduling-related search spaces.

In an implementation, the processor may be configured to further perform the following operation: obtaining a second condition combination by combining the tiling information with the first condition combination; obtaining a third condition combination by combining the data division information with the second condition combination; and obtaining a fourth condition combination by recombining a scheduling condition based on whether or not to reuse data in the third condition combination. In this case, when predicting a performance value, the processor may be configured to generate hardware modeling based on the fourth condition combination and predict a performance value through the hardware modeling.

In an implementation, when performing the predicting of a performance value, the processor may be configured to predict the performance value for each action performed by the artificial intelligence processor through the hardware modeling. In this case, after the predicting of a performance value, the processor is configured to further perform the following operation: assigning a weight to the predicted performance value for each action; and correcting the weight assigned for each action according to a ratio of an actual performance value obtained by a test for each action and the predicted performance value for each action.

### BRIEF DESCRIPTION OF THE DRAWINGS

FIG. 1 is a diagram showing the structure of an artificial intelligence processing apparatus according to an embodiment of the present disclosure.

FIG. 2 is a diagram showing the structure of an instruction generation apparatus according to an embodiment of the present disclosure.

FIG. 3A and FIG. 3B are flowcharts of an optimization method according to an embodiment of the present disclosure.

FIG. 4 and FIG. 5 are diagrams illustrating an example of a scheduling search space according to an embodiment of the present disclosure.

FIG. 6 and FIG. 7 are diagrams illustrating an example of recombining scheduling conditions in consideration of data reuse according to an embodiment of the present disclosure.

FIG. 8 is a flowchart illustrating a weight correction process in an optimization method according to an embodiment of the present disclosure.

FIG. 9 is a diagram showing the structure of an instruction generation apparatus according to an embodiment of the present disclosure.

### DETAILED DESCRIPTION OF THE EMBODIMENTS

In the following detailed description, only certain embodiments of the present disclosure have been shown and described, simply by way of illustration. Hereinafter, embodiments of the present disclosure will be described in detail with reference to the accompanying drawings so that those of ordinary skill in the art may easily implement the present disclosure. As those skilled in the art would realize, the described embodiments may be modified in various different ways, all without departing from the spirit or scope of the present disclosure. Accordingly, the drawings and description are to be regarded as illustrative in nature and not restrictive. Like reference numerals designate like elements throughout the specification.

Throughout the specification, in addition, unless explicitly described to the contrary, the word “comprise”, and variations such as “comprises” or “comprising”, will be understood to imply the inclusion of stated elements but not the exclusion of any other elements.

The expressions described in the singular may be interpreted as singular or plural unless an explicit expression such as “one”, “single”, and the like is used.

In addition, terms including ordinal numbers such as “first” and “second” used in embodiments of the present disclosure may be used to describe components, but the components should not be limited by the terms. The terms are only used to distinguish one component from another. For example, without departing from the scope of the present disclosure, a first component may be referred to as a second component, and similarly, the second component may be referred to as the first component.

The present disclosure is described by taking as an example a device having high parallel processing capability, that is, an artificial intelligence processing apparatus, using a systolic array-based calculator, such as a Tensor Processing Unit (TPU) among various architectures of an artificial intelligence processor. An artificial intelligence processing apparatus provides an automatic instruction generation apparatus and an optimization method for processing various neural network models with the most optimal performance.

Here, the artificial intelligence processing apparatus may include a deep learning accelerator of a neural network, and is not necessarily limited to the above example.

Hereinafter, an apparatus for automatically generating instructions for an artificial intelligence processor and an optimization method thereof according to an embodiment of the present disclosure will be described with reference to the drawings.

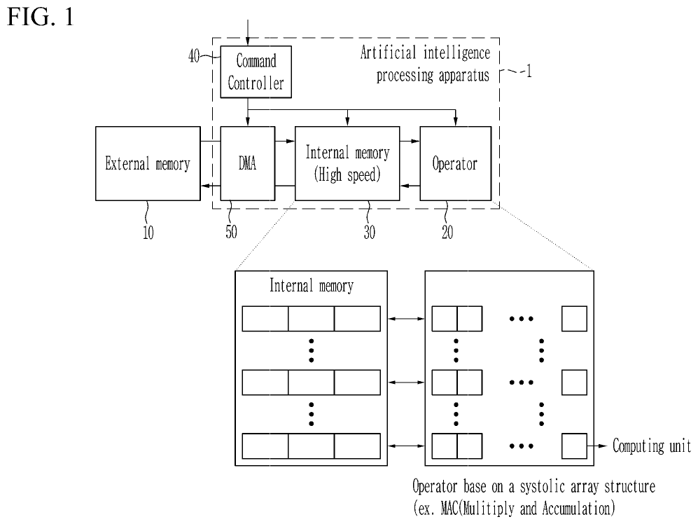

FIG. 1 is a diagram showing the structure of an artificial intelligence processing apparatus according to an embodiment of the present disclosure.

As shown in FIG. 1, an artificial intelligence processor according to an embodiment of the present disclosure, that is, an artificial intelligence processing apparatus 1, includes an external memory 10 that stores input/output data and weight data, an operator 20, and an internal memory 30 that provides data to the operator 20 and stores data output from the operator 20, and further includes an instruction controller 40 and a direct memory access (DMA) 50 located between the external memory 10 and the internal memory 30.

The operator 20 may be an operator based on a systolic array structure in which computation units are arranged at positions corresponding to rows and columns, as shown in FIG. 1, and accordingly, the internal memory 30 may also have a structure including individual registers corresponding to each array of the operator 20.

In the artificial intelligence processing apparatus 1 having such a structure, data access for the operation of the operator 20 is made only through the internal memory 30, and the artificial intelligence processing apparatus 1 according to an embodiment of the present disclosure may perform operations as follows.

(a) Input data LOADing (ILOAD) from external memory to internal memory (also referred to as the first action).

(b) Weight data LOADing (WLOAD) from external memory (also referred to as the second action).

(c) Multiplier accumulator operation (MMOP) (also referred to as the third action).

(d) Storing operation result (output) data into external memory (Output data storing, OSTR) (also referred to as the fourth action).

When performing these actions, the neural network handles a lot of data and the internal memory is configured to have a small size due to the cost required. In an embodiment of the present disclosure, in order to optimize the performance of the artificial intelligence processor, the following is considered.

Item 1: The allocation ratio of input data, weight data, and output data to internal memory.

Item 2: Tiling information that divides the entire data to store the data in the memory allocated for each component (where the component represents the component of the data, for example, it represents that the data is one of the input data, the weight, and the output data).

Item 3: Data slicing information on which data is to be placed in each row or column in the systolic array structure, considering the tiling information and the batch size to be processed.

Item 4: Optimization of performance by omitting actions required for data loading and storage by increasing the data reuse rate between adjacent layers of the neural network.

Item 5: Whether a double buffering technique that enables parallel actions in consideration of the dependency between actions to prevent performance degradation when the above four actions (a)-(d) of the artificial intelligence processing apparatus are sequentially processed is applied.

Item 6: Scheduling of actions in consideration of the dependency of sequential or parallel actions.

Item 7: Minimize fragmentation when allocating external memory for data that is not reused between layers through internal memory.

In consideration of these items (referred to optimization condition information for convenience of explanation), in an embodiment of the present disclosure, an instruction of the action of the artificial intelligence processing apparatus is automatically generated.

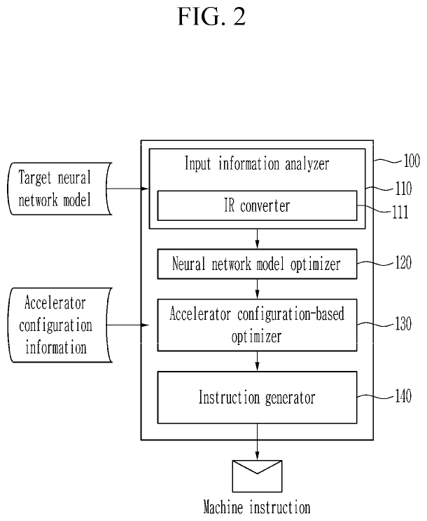

FIG. 2 is a diagram showing the structure of an instruction generation apparatus according to an embodiment of the present disclosure.

The instruction generation apparatus 100 (also referred to as a compiler) according to an embodiment of the present disclosure includes an input information analyzer 110, a neural network model optimizer 120, an accelerator configuration-based optimizer 130, and an instruction generator 140.

The input information analyzer 110 is configured to receive and analyze information related to a target neural network model, and may include an intermediate representation (IR) converter 111 that analyzes the input information and stores it in a predetermined data structure.

The neural network model optimizer 120 is configured to generate model optimization information by optimizing a corresponding neural network model based on analysis result data that is a result analyzed by the input information analyzer 110 and that has a certain data structure.

The accelerator configuration-based optimizer 130 is configured to generate optimal action information for optimizing the action of the accelerator based on the input accelerator (artificial intelligence processing apparatus) configuration information and model optimization information provided from the neural network model optimizer 120. Here, the accelerator configuration information may include hardware information of an accelerator, that is, an artificial intelligence processing apparatus.

The instruction generator 140 is configured to generate an instruction based on optimal action information provided from the accelerator configuration-based optimizer 130.

In consideration of the optimization condition information (item 1 to item 7) as described above, when the artificial intelligence processing apparatus 1 performs the actions (a) to (d) described above, the instruction generating apparatus 100 having such a structure predicts and compares the performance values of the artificial intelligence processing apparatus processing the random neural network model to optimize the performance as follows.

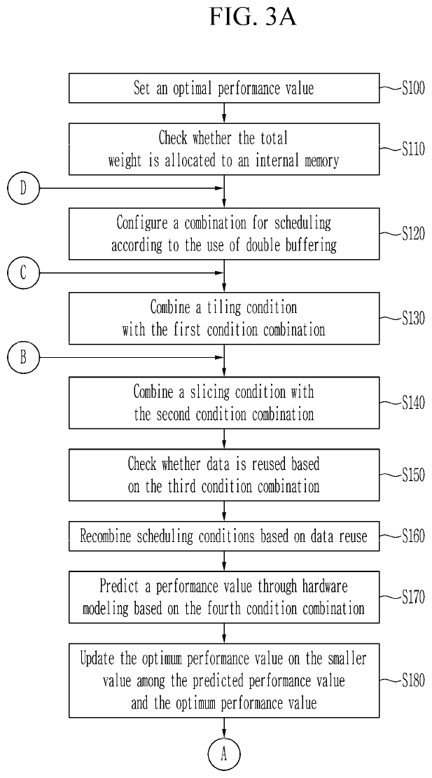

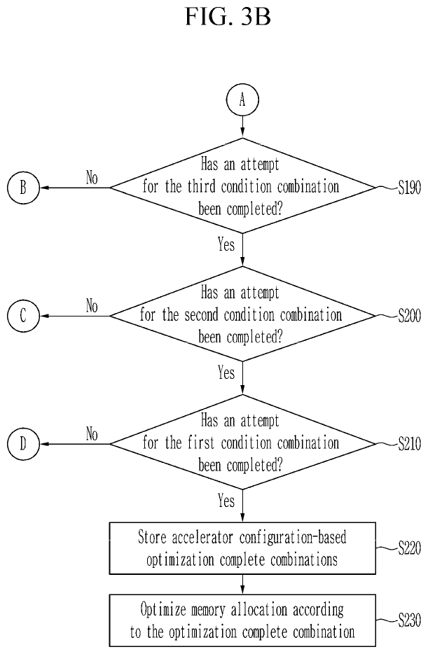

FIG. 3A and FIG. 3B are flowcharts of an optimization method according to an embodiment of the present disclosure.

In the instruction generation apparatus 1 according to an embodiment of the present disclosure, model optimization information optimized for a corresponding neural network model is generated based on analysis result data obtained by receiving and analyzing information related to the neural network model, and the action of the accelerator is optimized based on the generated model optimization information and accelerator configuration information to optimize. Here, the artificial intelligence processing apparatus is described as an example of a deep learning accelerator, and as described above, the description is based on the fact that model optimization information and accelerator configuration information have already been obtained.

First, as shown in FIG. 3A, the optimal performance value is set as the maximum value (MAX) (S100), and it is checked whether the total weight used in the corresponding neural network model is allocated to the internal memory of the accelerator (S110). The optimum performance value may be set for each action (the four defined accelerator actions (a) to (d)).

In addition, considering the dependency between the accelerator actions (a) to (d), it is determined whether double buffering to enable parallel action is used, and a combination for scheduling the accelerator actions (a) to (d) is configured according to the use of double buffering (S120). For example, based on the four accelerator actions (a) to (d) defined above, by combining the double buffering conditions for ILOAD, WLOAD, and OSTR actions, the condition for simultaneous access to the internal memory for input/output data for MMOP (the condition for whether spaces of the memory for input/output data is separated or integrated), and the result of the checking of whether the total weights is allocated in step S110, scheduling-related search spaces (also referred to as scheduling search spaces) to perform the accelerator actions (a) to (d) are defined, and are further defined in consideration of whether a weight priority mode or an input data priority mode is used. In this way, the combination (scheduling-related search spaces defined as above) for scheduling the accelerator actions (a) to (d) according to the use of double buffering is referred to as a first condition combination for convenience of description.

The scheduling search space may be formed as follows, for example.

1. When the total weight is allocable to an internal memory:

Scheduling search space=(whether input data is double buffered)×(whether output data is double buffered)×(whether spaces in memory for input/output data is separated or integrated)×(weight priority mode/input data priority mode)=2⁴=16 search spaces.

2. When the total weight cannot be allocated to the internal memory:

Scheduling search space=(whether input data is double buffered)×(whether output data is double buffered)×(whether weighted data is double buffered)×(whether spaces in memory for input/output data is separated or integrated)×(weight priority mode/input data priority mode)=2⁵=32 search spaces.

If it is checked that the total weights cannot be allocated in step S110, the scheduling search space corresponding to the first condition combination is set to a total of 32 search spaces.

On the other hand, if it is determined that the total weights can be allocated in step S110, the scheduling search space corresponding to the first condition combination is set as a total of 48 (16+32) search spaces.

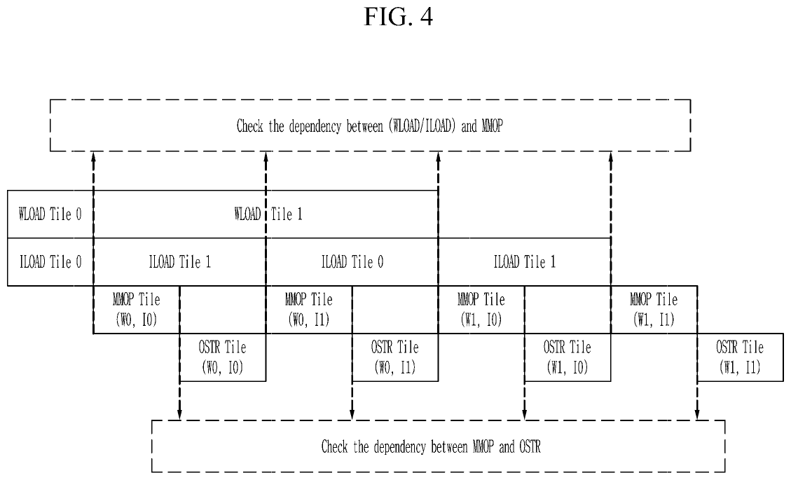

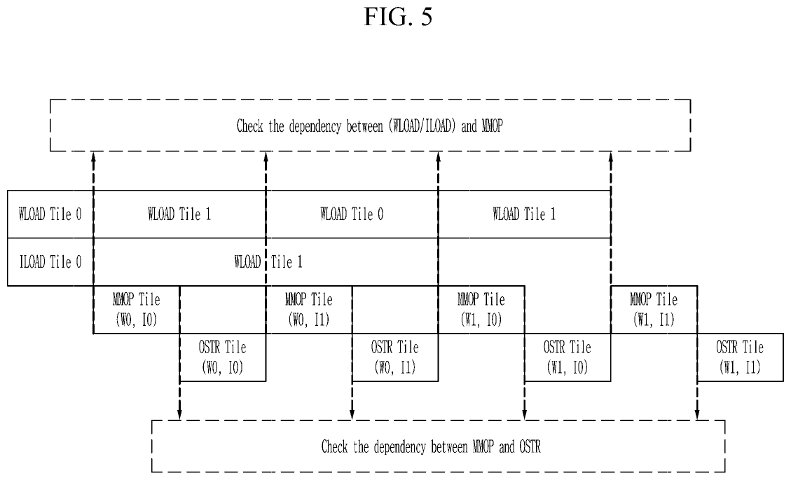

FIG. 4 and FIG. 5 are diagrams illustrating an example of a scheduling search space according to an embodiment of the present disclosure.

Specifically, the scheduling search space illustrated in FIG. 4 is an example showing one of 48 scheduling search spaces in the weight priority mode. In order to store data in the memory allocated for each component, the weight is composed of two tiles, and as shown in FIG. 4, when the double buffering of input data is used, a single buffer is used for output data, the double buffering of weight is used, and the space in the memory for input/output data is separated, a scheduling search space in which accelerator actions (ILOAD, WLOAD, MMOP, OSTR) are performed may be configured as shown in FIG. 4.

The scheduling search space shown in FIG. 5 is an example of one of 48 scheduling search spaces in the input data priority mode. In order to store data in the memory allocated for each component, input data is composed of two tiles, and as shown in FIG. 5, when the double buffering of input data is used, a single buffer is used for output data, the double buffering of weight is used, and the space in the memory for input/output data is separated, a scheduling search space in which accelerator actions (ILOAD, WLOAD, MMOP, OSTR) are performed may be configured as shown in FIG. 5.

Meanwhile, as shown in FIG. 3A, a tiling condition is combined with respect to the first condition combination (S130). The tiling information is combined with the first condition combination in which scheduling conditions for performing accelerator actions (a) to (d) while using double buffering are combined. In other words, by combining the tiling information for each space among the scheduling-related search spaces, the second condition combination is obtained. The second condition combination corresponds to the division of all data required to perform each action on the scheduling-related search space into the allocated area for each data component of the memory (the internal memory).

Then, a slicing condition (data division information) is combined with the second condition combination obtained in step S130 (S140). In consideration of the tiling information included in the second condition combination and the batch size to be processed, a third condition combination is obtained in which data is divided and arranged for each row or column of the operator of the accelerator.

Based on the third condition combination, it is checked whether data is reused between layers of the neural network (S150). If it is possible to reuse data between layers, the scheduling conditions for performing accelerator actions (a) to (d) are recombined in consideration of data reuse (S160). Accordingly, a fourth condition combination in which scheduling conditions based on data reuse is reflected for the third condition combination is obtained.

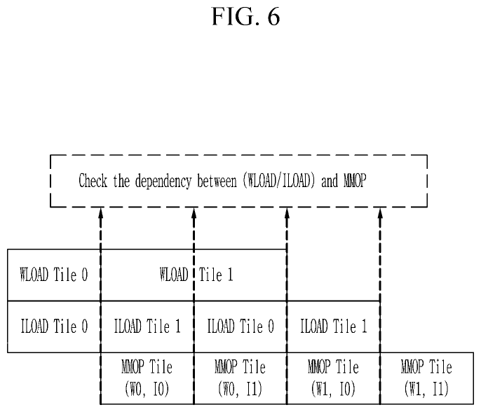

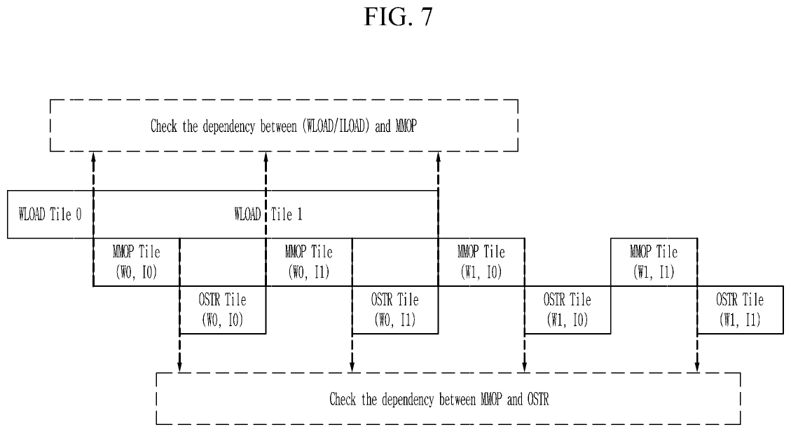

FIG. 6 and FIG. 7 are diagrams illustrating an example of recombining scheduling conditions in consideration of data reuse according to an embodiment of the present disclosure.

For example, if it is possible to reused the output data of the current layer as the input data of the next layer within the internal memory without moving the output data to the external memory, the OSTR for the current layer and the ILOAD for the next layer are removed and the dependency for this is removed, thereby the scheduling conditions is reset and then the fourth condition combination is obtained. In this case, double buffering conditions for input and output can also be removed.

When the scheduling search space defined in the weight priority mode shown in FIG. 4 is described as an example, if it is possible to reuse data as described above, the OSTR is removed from the scheduling search space for the current layer, as shown in FIG. 6, and then the scheduling conditions for the current layer are reset. In addition, as shown in FIG. 7, the ILOAD is removed from the scheduling search space for the next layer, and then the scheduling condition for the next layer is reset.

Meanwhile, as shown in FIG. 3A, a performance value is predicted through hardware modeling based on the fourth condition combination (S170). Using the accelerator configuration information and the model optimization information, optimized hardware modeling for performing the fourth condition combination is generated, and performance values are predicted through the generated hardware modeling, wherein the fourth condition combination corresponds to the condition combination in which the tiling condition, the slicing condition, and the scheduling conditions according to whether or not data is reused are reflected to the combination of the double buffering and related conditions for scheduling the accelerator action. Hardware modeling may include instructions for performing each action based on the fourth condition combination, and predicts a performance value when the accelerator performs the corresponding action based on these instructions. Here, hardware modeling may represent that the model, which can simulate the actual hardware operating according to the above combination of conditions, is made into software, and the model is designed to compute the performance value (for example, processing time or hardware operation time) of the combination of conditions.

The predicted performance value and the optimum performance value (the performance value set in step S100) are compared, and the optimum performance value is updated based on the smaller value among the predicted performance value and the optimum performance value (S180). For example, if the performance value indicates the hardware operation time, the case with the smallest operation time is interpreted as the optimal performance. Thus, if the predicted hardware operation time is less than the optimal performance value, the optimal performance value is updated according to the predicted hardware operation time.

The process of predicting this performance value and updating the optimal performance value through the comparison of the performance value and the optimal performance value is repeatedly performed for all of the condition combinations obtained in the above steps (S120, S130, and S140), and thus the optimal condition combination is determined to achieve the optimal performance. For example, the condition combination that occupies the smallest hardware operation time is determined as the optimization condition combination.

To this end, as shown in FIG. 3B, it is determined whether an attempt for the third condition combination obtained by combining the second condition combination with the slicing condition in step S140 has been completed (S190), and if the attempt for the third condition combination is not completed, the process returns to step S140, and steps S140 to S190 are again performed.

When the attempt for the combination of the third condition has been completed, it is determined whether the attempt for the combination of the second condition has been completed (S200), and if the attempt for the combination of the second condition has not been completed, the process returns to step S130, and steps S130 to S200 are again performed.

If the attempt for the second condition combination has been completed, it is determined whether the attempt for the first condition combination has been completed (S210), and if the attempt for the first condition combination has not been completed, the process returns to step S120, and steps S120 to S210 are again performed.

In an embodiment of the present disclosure, it is determined whether the attempt has been completed in the order of the third condition combination obtained by combining a slicing condition, the second condition combination obtained by combining a tiling condition, and the first condition combination, so that the optimization execution time for performing the attempt to find an optimization condition combination for each condition combination is reduced. To this end, early termination conditions are placed at a lower level to facilitate insertion in the loop for the slicing condition or the tiling condition, granularity is placed from large to small in relation to data shape decisions in memory, and then it is determined whether the attempt has been completed in the order of the third condition combination, the second condition combination obtained by combining the tiling condition, and the first condition combination.

For example, for a slicing condition or a tiling condition, starting from a lower level, for example, data with a small number of tiles, if the data of the corresponding tile can be accommodated in the internal memory, the condition may be set so that initial termination is possible and the condition may be set to secure two memory spaces for input for double buffering.

However, the present disclosure is not limited to the determining whether an attempt has been completed in the order of the third condition combination obtained by combining the slicing condition, the second condition combination obtained by combining the tiling condition, and the first condition combination.

On the other hand, when the attempt for the first condition combination has been completed, that is, when the tiling information combination, the slicing condition combination, and the scheduling condition recombination according to data reuse are completed in relation to all the scheduling-related search spaces defined in step S120, the condition combinations performed so far are stored as the accelerator configuration-based optimization complete combination (S220). In addition, memory allocation optimization is performed according to the optimization complete combination (S230). That is, instructions according to optimal scheduling for performing the four actions defined above is generated, data is loaded and provided to the operator according to each instruction, and memory allocation optimization in which the output data of the operator is stored is performed.

In this way, based on the four actions defined above, by combining the double buffering conditions for ILOAD, WLOAD, and OSTR actions, the condition for simultaneous access to the internal memory for input/output data for MMOP, and whether the total weights are allocated, a scheduling-related search space may be defined, and a predicted performance value, that is, a performance value predicted for each of the defined search spaces through hardware modeling, is extracted to perform scheduling with optimal performance.

Meanwhile, when extracting the predicted performance value, performance modeling of the MMOP which is an action between the internal memory and the operator, can be accurately predicted according to the size of the allocated data. However, in the case of ILOAD, WLOAD, and OSTR actions that transfer data between the external memory and the internal memory, it may be difficult to accurately predict because they act differently depending on the bus configuration between the two memories.

In an embodiment of the present disclosure, in order to correct this uncertainty, the predicted performance values predicted through the hardware modeling for the four action operation configurations are multiplied by weights for each of the four actions, and the weight values are updated and corrected after testing from an actual processor.

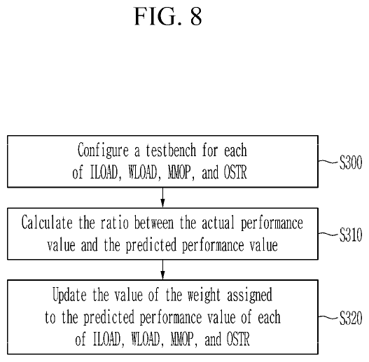

FIG. 8 is a flowchart illustrating a weight correction process in an optimization method according to an embodiment of the present disclosure.

In the optimization method as described above, when the performance value is predicted through the generated hardware modeling, a weight is given to the predicted performance value of each of the four actions performed, i.e., ILOAD, WLOAD, MMOP, and OSTR, and a testbench for ILOAD, WLOAD, MMOP, and OSTR is configured (S300). Then, a test is performed (for example, a test is performed on a system on chip (SoC)) to obtain an actual performance value for each action, and the ratio between the obtained actual performance value and the predicted performance value is calculated (S310).

Then, the value of the weight assigned to each action is updated according to the calculated ratio (S320). That is, by correcting the value of the weight assigned to the predicted performance value of each action according to the result of step S310, it is possible to correct the uncertainty of prediction for each action.

In this way, after the predicted performance value for each action is corrected, it may be compared with the optimal performance value in step S180 in the above optimization method.

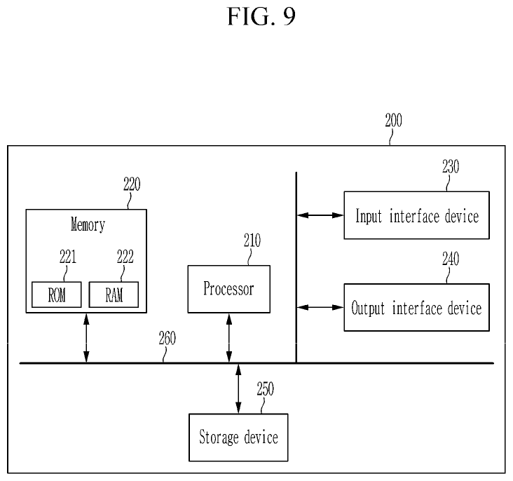

FIG. 9 is a diagram showing the structure of an instruction generation apparatus according to an embodiment of the present disclosure.

The instruction generation apparatus according to an embodiment of the present disclosure may be implemented as a computer system, as shown in FIG. 9.

The instruction generation apparatus 200 includes a processor 210, a memory 220, an input interface device 230, an output interface device 240, and a storage device 250. Each of the components may be connected by a bus 260 to communicate with each other. Also, each of the components may be connected through an individual interface or individual bus centered on the processor 210 instead of the common bus 260.

The processor 210 may execute a program command stored in at least one of the memory 220 and the storage device 250. The processor 210 may be a central processing unit (CPU) or a dedicated processor for performing the forgoing methods according to embodiments of the present disclosure.

The processor 210 may be configured to embody the functions and methods described based on FIGS. 1 to 8 above.

The memory 220 is connected to the processor 210 and stores various information related to the action of the processor 210. The memory 220 stores instructions for an action to be performed by the processor 110, or may temporarily store an instruction loaded from the storage device 250. The processor 210 may execute instructions that are stored or loaded into the memory 220. The memory 220 may include a ROM 221 and a RAM 222.

In an embodiment of the present disclosure, the memory 220 and the storage device 250 may be located inside or outside the processor 210, and the memory 220 and the storage device 250 may be connected to the processor 210 through various known means.

According to an embodiment of the present disclosure, an artificial intelligence dedicated processor (or a deep learning accelerator of a neural network) can process various neural network models with the most optimal performance through a dedicated instruction automatic generation apparatus having an optimization algorithm, and therefore it is possible to maximize and automate the efficiency of the artificial intelligence dedicated processor or a deep learning accelerator in a neural network.

In addition, by analyzing the currently developed artificial intelligence processors, classifying actions for hardware performance optimization, defining problems, and presenting algorithms to solve them, the performance of the system can be maximized based on the automatic instruction generation apparatus of the deep learning system.

The embodiments of the present disclosure are not implemented only through the apparatus and/or method described above, but may be implemented through a program for realizing a function corresponding to the configuration of the embodiment of the present disclosure, and a recording medium in which the program is recorded. This implementation can also be easily performed by expert person skilled in the technical field to which the present disclosure belongs from the description of the above-described embodiments.

The components described in the embodiment s may be implemented by hardware components including, for example, at least one digital signal processor (DSP), a processor, a controller, an application-specific integrated circuit (ASIC), a programmable logic element such as an FPGA, other electronic devices, or combinations thereof. At least some of the functions or the processes described in the embodiment s may be implemented by software, and the software may be recorded on a recording medium. The components, functions, and processes described in the embodiment s may be implemented by a combination of hardware and software.

The method according to embodiment s may be embodied as a program that is executable by a computer, and may be implemented as various recording media such as a magnetic storage medium, an optical reading medium, and a digital storage medium. Various techniques described herein may be implemented as digital electronic circuitry, or as computer hardware, firmware, software, or combinations thereof. The techniques may be implemented as a computer program product, i.e., a computer program tangibly embodied in an information carrier, e.g., in a machine-readable storage device (for example, a computer-readable medium) or in a propagated signal for processing by, or to control an operation of a data processing apparatus, e.g., a programmable processor, a computer, or multiple computers. A computer program(s) may be written in any form of a programming language, including compiled or interpreted languages, and may be deployed in any form including a stand-alone program or a module, a component, a subroutine, or other units appropriate for use in a computing environment. A computer program may be deployed to be executed on one computer or on multiple computers at one site or distributed across multiple sites and interconnected by a communication network. Processors appropriate for execution of a computer program include, by way of example, both general and special purpose microprocessors, and any one or more processors of any kind of digital computer. Generally, a processor will receive instructions and data from a read-only memory or a random access memory or both. Elements of a computer may include at least one processor to execute instructions and one or more memory devices to store instructions and data. Generally, a computer will also include or be coupled to receive data from, transfer data to, or perform both on one or more mass storage devices to store data, e.g., magnetic disks, magneto-optical disks, or optical disks. Examples of information carriers appropriate for embodying computer program instructions and data include semiconductor memory devices, for example, magnetic media such as a hard disk, a floppy disk, and a magnetic tape, optical media such as a compact disk read only memory (CD-ROM), a digital video disk (DVD), etc., and magneto-optical media such as a floptical disk, and a read only memory (ROM), a random access memory (RAM), a flash memory, an erasable programmable ROM (EPROM), and an electrically erasable programmable ROM (EEPROM), and any other known computer readable medium. A processor and a memory may be supplemented by, or integrated with, a special purpose logic circuit. The processor may run an operating system (OS) and one or more software applications that run on the OS. The processor device also may access, store, manipulate, process, and create data in response to execution of the software. For the purpose of simplicity, the description of a processor device is used as singular; however, one skilled in the art will appreciate that a processor device may include multiple processing elements and/or multiple types of processing elements. For example, a processor device may include multiple processors or a processor and a controller. In addition, different processing configurations are possible, such as parallel processors. Also, non-transitory computer-readable media may be any available media that may be accessed by a computer, and may include both computer storage media and transmission media. The present specification includes details of a number of specific implementations, but it should be understood that the details do not limit any disclosure or what is claimable in the specification but rather describe features of the specific embodiment. Features described in the specification in the context of individual embodiment s may be implemented as a combination in a single embodiment. In contrast, various features described in the specification in the context of a single embodiment may be implemented in multiple embodiment s individually or in an appropriate sub-combination. Furthermore, the features may operate in a specific combination and may be initially described as claimed in the combination, but one or more features may be excluded from the claimed combination in some cases, and the claimed combination may be changed into a sub-combination or a modification of a sub-combination. Similarly, even though operations are described in a specific order in the drawings, it should not be understood that the operations needing to be performed in the specific order or in sequence to obtain desired results or as all the operations needing to be performed. In a specific case, multitasking and parallel processing may be advantageous. In addition, it should not be understood as requiring a separation of various apparatus components in the above-described embodiment s in all embodiment s, and it should be understood that the above-described program components and apparatuses may be incorporated into a single software product or may be packaged in multiple software products. It should be understood that the embodiment s disclosed herein are merely illustrative and are not intended to limit the scope of the disclosure. It will be apparent to one of ordinary skill in the art that various modifications of the embodiment s may be made without departing from the spirit and scope of the claims and their equivalents.

What is claimed is:

1. A method of optimizing an artificial intelligence processor, comprising:
obtaining a combination of conditions for actions performed by the artificial intelligence processor in consideration of optimization condition information for the actions based on model optimization information that optimizes a neural network model to which the artificial intelligence processor is applied and configuration information of the artificial intelligence processor;
generating hardware modeling based on the combination of conditions and predicting a performance value through the hardware modeling; and
determining an optimal combination of conditions by comparing the predicted performance value and a preset optimal performance value.

2. The method of claim 1, wherein
the determining of an optimal condition combination comprises
updating the optimal performance value to a smaller value as a result of comparing the predicted performance value with the preset optimal performance value.

3. The method of claim 2, wherein
the predicting of a performance value and the updating are repeatedly performed for a combination of conditions that can be combined to perform the actions, and
the determining of an optimal condition combination comprises
determining an optimal combination of conditions when the predicting of a performance value and the updating are performed for all conditions included in the condition combination.

4. The method of claim 1, wherein
the optimization condition information comprises
an allocation ratio of input data, weight data, and output data to the internal memory of the artificial intelligence processor, tiling information for dividing the entire data, data division information, whether or not to reuse data between adjacent layers of a neural network, whether or not to apply a double buffering technique to enable parallel operation in consideration of dependency between the actions for each action operation, and scheduling of actions.

5. The method of claim 4, wherein
the actions comprises
a first action of loading input data from an external memory of the artificial intelligence processor to an internal memory, a second action of loading weight data from the external memory, a third action of the artificial intelligence processor performing an operation, and a fourth action of storing result data of the operation to the external memory.

6. The method of claim 5, wherein
the obtaining of a combination of conditions comprises
obtaining a first condition combination, based on the allocation ratio, whether or not to apply a double buffering technique, and scheduling of actions, by combining a double buffering condition, a condition for simultaneous access to the internal memory for input data and output data for the third action, and whether the total weights are allocated, wherein the first condition combination corresponds to scheduling-related search spaces.

7. The method of claim 6, wherein
the first condition combination comprises a scheduling related search space according to a weight priority mode and a scheduling related search space according to an input data priority mode.

8. The method of claim 6, wherein
the obtaining of a combination of conditions comprises:
obtaining a second condition combination by combining the tiling information with the first condition combination;
obtaining a third condition combination by combining the data division information with the second condition combination; and
obtaining a fourth condition combination by recombining a scheduling condition based on the whether or not to reuse data in the third condition combination.

9. The method of claim 8, wherein
the predicting of a performance value comprises
generating hardware modeling based on the fourth condition combination and predicting a performance value through the hardware modeling.

10. The method of claim 1, wherein
the predicting of a performance value predicts the performance value for each action performed by the artificial intelligence processor through the hardware modeling, and
after the predicting of a performance value,
the method further comprises
assigning a weight to the predicted performance value for each action, and correcting the weight assigned for each action according to a ratio of an actual performance value obtained by a test for each action and the predicted performance value for each action.

11. The method of claim 1, wherein
the artificial intelligence processor is an accelerator of a systolic array structure.

12. An apparatus of generating an instruction for an action of an artificial intelligence processor, comprising:
an interface device; and
a processor connected to the interface device and configured to obtain optimal combination of conditions for actions performed by the artificial intelligence processor based on model optimization information that optimizes a neural network model to which the artificial intelligence processor is applied and configuration information of the artificial intelligence processor and generate an instruction according to the optimal condition combination,
wherein the processor is configured to perform the following operations:
obtaining a combination of conditions for actions performed by the artificial intelligence processor in consideration of optimization condition information for the actions;
generating hardware modeling based on the combination of conditions and predicting a performance value through the hardware modeling; and
determining an optimal combination of conditions by comparing the predicted performance value and a preset optimal performance value.

13. The apparatus of claim 11, wherein
the processor is configured to update the optimal performance value to a smaller value as a result of comparing the predicted performance value with the preset optimal performance value, and
the predicting of a performance value and the updating are repeatedly performed for a combination of conditions that can be combined to perform the actions.

14. The apparatus of claim 13, wherein
the processor is configured to determine an optimal combination of conditions when the predicting of a performance value and the updating are performed for all conditions included in the condition combination and generate an instruction according to the optimal condition combination.

15. The apparatus of claim 12, wherein
the optimization condition information comprises
an allocation ratio of input data, weight data, and output data to the internal memory of the artificial intelligence processor, tiling information for dividing the entire data, data division information, whether or not to reuse data between adjacent layers of a neural network, whether or not to apply a double buffering technique to enable parallel operation in consideration of dependency between the actions for each action operation, and scheduling of actions.

16. The apparatus of claim 15, wherein
the actions performed by the artificial intelligence processor comprises a first action of loading input data from an external memory of the artificial intelligence processor to an internal memory, a second action of loading weight data from the external memory, a third action of the artificial intelligence processor performing an operation, and a fourth action of storing result data of the operation to the external memory.

17. The apparatus of claim 16, wherein
when performing the obtaining of a combination of conditions, the processor is configured to perform the following operation:
obtaining a first condition combination, based on the allocation ratio, whether or not to apply a double buffering technique, and scheduling of actions, by combining a double buffering condition, a condition for simultaneous access to the internal memory for input data and output data for the third action, and whether the total weights are allocated, wherein the first condition combination corresponds to scheduling-related search spaces.

18. The apparatus of claim 17, wherein
the processor is configured to further perform the following operation:
obtaining a second condition combination by combining the tiling information with the first condition combination;
obtaining a third condition combination by combining the data division information with the second condition combination; and
obtaining a fourth condition combination by recombining a scheduling condition based on the whether or not to reuse data in the third condition combination, and
when predicting a performance value, the processor is configured to generate hardware modeling based on the fourth condition combination and predict a performance value through the hardware modeling.

19. The apparatus of claim 12, wherein
when performing the predicting of a performance value, the processor is configured to predict the performance value for each action performed by the artificial intelligence processor through the hardware modeling, and
after the predicting of a performance value, the processor is configured to further perform the following operation:
assigning a weight to the predicted performance value for each action, and correcting the weight assigned for each action according to a ratio of an actual performance value obtained by a test for each action and the predicted performance value for each action.
